(19) United States
(12) Patent Application Publication
(10) Pub. No.: US 2017/0261817 A1
(43) Pub. Date: Sep. 14, 2017

(54) TFT Array Substrate, LCD Panel and Method of Fabricating the Same

(71) Applicant: Shenzhen China Star Optoelectronics Technology Co., Ltd., Shenzhen, Guangdong (CN)

(72) Inventors: Yongchao ZHAO, Shenzhen, Guangdong (CN); Chung-ching HSIEH, Shenzhen, Guangdong (CN); Rentang ZHAO, Shenzhen, Guangdong (CN)

(73) Assignee: Shenzhen China Star Optoelectronics Technology Co., Ltd., Shenzhen, Guangdong (CN)

(21) Appl. No.: 14/908,525

(22) PCT Filed: Dec. 25, 2015
(86) PCT No.: PCT/CN2015/098966

§ 371 Date: Jan. 28, 2016

(30) Foreign Application Priority Data
Oct. 9, 2015 (CN) 201510648877.6

(51) Int. Cl. G02F 1/1337; G02F 1/1362; G02F 1/1343; G02F 1/1368

(52) U.S. Cl. CPC G02F 1/133788; G02F 1/1368; G02F 1/136209; G02F 1/134309; G02F 1/133723; G02F 2001/136222; G02F 2201/121; G02F 2201/123; G02F 2202/02; G02F 2001/133769

(57) ABSTRACT

The present disclosure proposes a thin-film transistor (TFT) array panel, a display panel, and a method for fabricating the same. The TFT array panel includes a first substrate, and a gate layer, a buffer layer, a semiconductor layer, a first insulating layer, a color filter layer, a second insulating layer, and a first alignment layer formed on the first substrate successively. The color filter layer includes a black matrix section, and the black matrix section is opposite to the semiconductor layer along a vertical direction. The alignment substrate includes a second substrate and a second alignment layer formed on the second substrate. The first alignment layer and the second alignment layer are arranged near the liquid crystal layer. In this way, the performance of the semiconductor will not be affected by the ultraviolet polarizing light after being illuminated.

### BACKGROUND OF THE INVENTION

1. Field of the Invention

The present invention relates to the technology of displays, and more particularly, to a thin-film transistor (TFT) array panel, a display panel, and a method of fabricating the TFT array panel and the display panel.

2. Description of the Prior Art

A thin film transistor liquid crystal display (TFT-LCD) has advantages of compactness, low power consumption, and no radiation, that's why it prevails in recent years.

Currently, liquid crystal panels are categorized into twist nematic (TN), vertical alignment (VA), in plane switching (IPS), fringe field switching (FFS), and so on according to initial arrangement of liquid crystal and motion of liquid crystal in the electric field. Especially, IPS and FFS display modes have features of high contrast and quick response, so they are widely applied to liquid crystal panels.

Liquid crystal needs to be initially aligned when liquid crystal panels are fabricated adopting IPS and FFS display modes. The conventional liquid crystal alignment method is rubbing on liquid crystal alignment. The process is as follows: A rubbing roller carrying fine hair rolls and rubs an alignment film arranged on the array substrate and the color filter substrate for forming a tilt angle on the alignment film in the same direction. So the liquid crystal molecules can be arranged at the tilt angle in the same direction for consistent optical rotation. However, rubbing alignment may pollute the alignment film because of particles, resulting in a poor yield rate. Besides, rubbing alignment may generate static electricity which may damage transistors, resulting in faulty quality liquid crystal panels.

The mainstream alignment method is the photo-alignment method in the techniques of IPS and FFS. However, semiconductor material tends to leak electricity when ultraviolet light illuminates the semiconductor in the process of photo-alignment, thereby resulting in the performance of the device.

### SUMMARY OF THE INVENTION

An object of the present invention is to propose a TFT array substrate, a display panel, and a method of fabricating the TFT array substrate and the display panel. The ultraviolet polarizing light does not illuminate the semiconductor layer in the process of photo-alignment, so the performance of the TFT components improves.

According to the present invention, a thin-film transistor (TFT) array panel comprises a first substrate, and a gate layer, a buffer layer, a semiconductor layer, a first insulating layer, a color filter layer, a second insulating layer, and a first alignment layer formed on the first substrate successively. The color filter layer comprises a black matrix section, and the black matrix section is opposite to the semiconductor layer along a vertical direction. The alignment substrate comprises a second substrate and a second alignment layer formed on the second substrate, and the first alignment layer and the second alignment layer are arranged near the liquid crystal layer.

Furthermore, a common electrode layer is further arranged between the first insulating layer and the color filter layer. A pixel electrode layer is further arranged between the second insulating layer and the first alignment layer.

Furthermore, the buffer layer is either a SiOx layer or a SiNx layer. Each of the first insulating layer and the second insulating layer is an organic insulating layer.

Furthermore, the semiconductor layer is an indium gallium zinc oxide (IGZO) layer.

Furthermore, a direction of connection of the black matrix section and the semiconductor layer and a vertical direction form a preset angle.

According to the present invention, a display panel comprises a thin-film transistor (TFT) array panel, an alignment substrate, and a liquid crystal layer sandwiched between the TFT array substrate and the alignment substrate. The TFT array panel comprises a first substrate, and a gate layer, a buffer layer, a semiconductor layer, a first insulating layer, a color filter layer, a second insulating layer, and a first alignment layer formed on the first substrate successively. The color filter layer comprises a black matrix section, and the black matrix section being opposite to the semiconductor layer along a vertical direction. The alignment substrate comprises a second substrate and a second alignment layer formed on the second substrate, and the first alignment layer and the second alignment layer are arranged near the liquid crystal layer.

Furthermore, a common electrode layer is further arranged between the first insulating layer and the color filter layer. A pixel electrode layer is further arranged between the second insulating layer and the first alignment layer.

Furthermore, the buffer layer is either a SiOx layer or a SiNx layer. Each of the first insulating layer and the second insulating layer is an organic insulating layer.

Furthermore, the semiconductor layer is an indium gallium zinc oxide (IGZO) layer.

Furthermore, a direction of connection of the black matrix section and the semiconductor layer and a vertical direction form a preset angle.

According to the present invention, a method of fabricating a display panel comprises: forming a gate layer, a buffer layer, a semiconductor layer, a first insulating layer, a color filter layer, a second insulating layer, and a first alignment layer on a first substrate successively, the color filter layer comprising a black matrix section, and the black matrix section being opposite to the semiconductor layer along a vertical direction; illuminating the first alignment film with an ultraviolet polarizing light from one side of the first alignment film away from the first substrate for forming a thin-film transistor (TFT) array substrate; forming a second alignment layer on the second substrate; illuminating the second alignment film with the ultraviolet polarizing light from one side of the second alignment film away from the second substrate for forming an alignment substrate; arranging the TFT array substrate and the alignment film in layers and forming a liquid crystal layer sandwiched between the first alignment film and the second alignment film.

Furthermore, the step of forming the gate layer, the buffer layer, the semiconductor layer, the first insulating layer, the color filter layer, the second insulating layer, and the first alignment layer on the first substrate successively comprises concrete steps of: forming a gate layer, a buffer layer, a semiconductor layer, a first insulating layer, a common electrode layer, a color filter layer, a second insulating layer, a pixel electrode layer, and a first alignment layer on the first substrate successively.

Furthermore, a direction of connection of the black matrix section and the semiconductor layer and a vertical direction form a preset angle. The step of illuminating the first alignment film with the ultraviolet polarizing light from one side of the first alignment film away from the first substrate for forming the TFT array substrate concretely comprises: illuminating the first alignment film with the ultraviolet polarizing light at the preset angle from one side of the first alignment film away from the first substrate for forming the TFT array substrate.

Furthermore, the wavelength of the ultraviolet polarizing light ranges from 200 nm to 400 nm.

Furthermore, the buffer layer is either a SiOx layer or a SiNx layer. Each of the first insulating layer and the second insulating layer is an organic insulating layer.

Furthermore, the semiconductor layer is an indium gallium zinc oxide (IGZO) layer.

Compared with conventional technology, the present invention proposes a TFT array substrate. The TFT array substrate comprises a first substrate, and a gate layer, a buffer layer, a semiconductor layer, a first insulating layer, a color filter layer, a second insulating layer, and a first alignment layer formed on the first substrate successively. The color filter layer comprises a black matrix section. The black matrix section is opposite to the semiconductor layer along a vertical direction. With the aforementioned method, when the ultraviolet polarizing light illuminates the alignment film from one side of an alignment principle substrate, the black matrix section can block the ultraviolet polarizing light and prevent the ultraviolet polarizing light from illuminating the semiconductor layer in the process of photo-alignment for the TFT substrate. In this way, the performance of the semiconductor will not be affected by the ultraviolet polarizing light after being illuminated.

### BRIEF DESCRIPTION OF THE DRAWINGS

FIG. 1 shows a schematic diagram of a TFT array substrate according to a first embodiment of the present invention.

FIG. 2 is a top view of the color filter layer of the TFT array substrate as shown in FIG. 1.

FIG. 3 shows a schematic diagram of a TFT array substrate according to a second embodiment of the present invention.

FIG. 4 shows a display panel according to one embodiment of the present invention.

FIG. 5 shows a detailed structure of the display panel.

FIG. 6 is a flow chart of a method of fabricating a display panel according to one embodiment of the present invention.

### DETAILED DESCRIPTION OF THE PREFERRED EMBODIMENTS

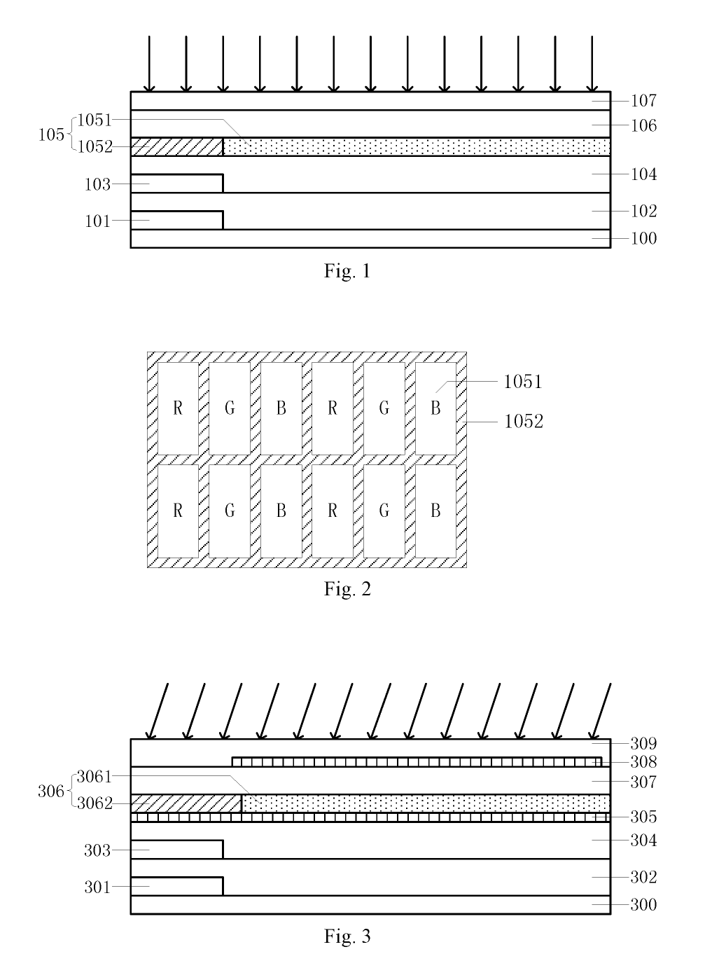

Please refer to FIG. 1 showing a schematic diagram of a TFT array substrate according to a first embodiment of the present invention. The TFT array substrate comprises a first substrate 100, a gate layer 101, a buffer layer 102, a semiconductor layer 103, a first insulating layer 104, a color filter layer 105, a second insulating layer 106, and a first alignment layer 107. Besides, the gate layer 101, the buffer layer 102, the semiconductor layer 103, the first insulating layer 104, the color filter layer 105, the second insulating layer 106, and the first alignment layer 107 are formed on the first substrate 100 successively.

The aforementioned layers are disposed on the first substrate 100 by means of physical vapor deposition (PVD) or chemical vapor deposition (CVD).

The first substrate 100 is basically a transparent glass substrate. But a transparent plastic substrate may be used when a flexible and curved display panel is fabricated.

The gate layer 101 is basically fabricated from chromium (Cr) and an alloy of Cr, an alloy of molybdenum (Mo) and tantalum (Ta), aluminum (Al) and an alloy of Al, titanium (Ti), copper (Cu), or tungsten (W). It is notified that the gate layer 101 has been etched and wears a pattern.

The buffer layer 102 can be called as the gate insulating layer. The buffer layer 102 comprises one or two layers. If the buffer layer 102 comprises one layer, the layer is either SiOx or SiNx or the compound of SiOx and SiNx. If the buffer layer 102 comprises two layers, one of the layers is SiOx, and the other is SiNx.

The semiconductor layer 103 is also called as the active layer. The semiconductor layer 103 may be an amorphous silicon (a-Si) semiconductor layer or a polycrystalline silicon (p-Si) semiconductor layer. The semiconductor layer 103 may also be a metallic oxide semiconductor layer such as indium gallium zinc oxide (IGZO). It is notified that the semiconductor layer 103 has been etched and wears a pattern. The semiconductor layer 103 is opposite to the gate layer 101 wearing a pattern along a vertical direction.

The first insulating layer 104 and the second insulating layer 106 may have a structure similar to the structure of the buffer layer 102 or comprise an organic insulating layer made of organic materials such as benzocyclobutene (C8H8).

The first alignment layer 107 is formed by polyimide (PI) liquid basically. Polyimide (PI) with an ultraviolet ray photo-reactive group and a solvent are the constituents of the PI liquid. The PI liquid is a chemical liquid for fabricating an LCD alignment film. After being printed on a conductive glass, the PI liquid is baked and the alignment film is formed. The rotating direction of liquid crystal modules with a tilt angle is more consistent.

The color filter layer 105 comprises a color filter section 1051 and a black matrix section 1052. The black matrix section 1052 is opposite to the semiconductor layer 103 along a vertical direction.

Specifically, the color filter layer 105, corresponding to the entire TFT substrate, comprises a plurality of color filter sections 1051 distributed in an array with different colors as FIG. 2 shows. The black matrix section 1052 is arranged between every two adjacent color filter sections 1051.

The color filter layer 105 comprises three filters, which are disposed successively in one embodiment. The three filters are red (R), green (G), and blue (B), respectively. Each of the filters corresponds to a pixel, that is, a TFT.

The black matrix section 1052 is opaque and is deposited on the areas among the primary colors red (R), green (G), and blue (B). The main function of the black matrix section 1052 is to avoid backlight leakage, to enhance contrast, to prevent color mixing, and to increase purity of color. Because the optical density (OD) of the black matrix section 1052 has to reach three, the method of sputtering a chromium (Cr) layer on the substrate for photo-etching a desired pattern is still adopted. However, resin photoresist comprising black dye has been used in recent years. In other words, the method of fabricating the black matrix with photo-etching becomes more and more popular.

In other embodiments, the color filter layer 105 in a conventional color filter (CF) substrate can be arranged in the TFT substrate.

In addition, the TFT substrate may be used in the TN LCD in one embodiment. If so, the TFT substrate further comprises a pixel electrode. The TFT substrate may be used in the IPS LCD or the FFS LCD in one embodiment. If so, the TFT substrate further comprises a pixel electrode and a common electrode.

Please refer to FIG. 1 again. When the ultraviolet polarizing light illuminates the first alignment layer 107 from one side of the alignment principle substrate vertical to the top of the array substrate in the process of photo-alignment for the aforementioned TFT substrate, the black matrix section 1052 can block the ultraviolet polarizing light and prevent the ultraviolet polarizing light from illuminating the semiconductor layer 103. This is because the black matrix section 1052 in the color filter layer 105 is opposite to the semiconductor layer 103 along a vertical direction.

Compared with conventional technology, the present invention proposes a TFT array substrate. The TFT array substrate comprises a first substrate, and a gate layer, a buffer layer, a semiconductor layer, a first insulating layer, a color filter layer, a second insulating layer, and a first alignment layer formed on the first substrate successively. The color filter layer comprises a black matrix section. The black matrix section is opposite to the semiconductor layer along a vertical direction. With the aforementioned method, when the ultraviolet polarizing light illuminates the alignment film from one side of an alignment principle substrate, the black matrix section can block the ultraviolet polarizing light and prevent the ultraviolet polarizing light from illuminating the semiconductor layer in the process of photo-alignment for the TFT substrate. In this way, the performance of the semiconductor will not be affected by the ultraviolet polarizing light after being illuminated.

Please refer to FIG. 3 showing a schematic diagram of a TFT array substrate according to a second embodiment of the present invention. The TFT array substrate comprises a first substrate 300, a gate layer 301, a buffer layer 302, a semiconductor layer 303, a first insulating layer 304, a common electrode 305, a color filter layer 306, a second insulating layer 307, a pixel electrode layer 308, and a first alignment layer 309. Moreover, the gate layer 301, the buffer layer 302, the semiconductor layer 303, the first insulating layer 304, the common electrode 305, the color filter layer 306, the second insulating layer 307, the pixel electrode layer 308, and the first alignment layer 309 are formed on the first substrate 300 successively.

Different from the first embodiment, a common electrode layer 305 is further arranged between the first insulating layer 304 and the color filter layer 306, and a pixel electrode layer 308 is further arranged between the second insulating layer 307 and the first alignment layer 309 in this embodiment.

Specifically, the buffer layer 301 may be fabricated from SiOx or SiNx. Each of the first insulating layer 304 and the second insulating layer 307 is an organic insulating layer. The semiconductor layer 303 is an oxide semiconductor layer such as IGZO.

The color filter layer 306 comprises a color filter section 3061 and a black matrix section 3062 in this embodiment. The direction of the connection of the black matrix section 3062 and the semiconductor layer 303 and a vertical direction form a preset angle.

Differing from the first embodiment, the black matrix section 3062 can properly extends towards the color filter section 3061 in the same pixel in this embodiment. In the process of photo-alignment for the TFT substrate, when the ultraviolet polarizing light illuminates the alignment film obliquely from one side of the alignment principle substrate, the black matrix section 3062 can block the ultraviolet polarizing light and prevent the ultraviolet polarizing light from illuminating the semiconductor layer 303. In this way, the performance of the semiconductor will not be affected by the ultraviolet polarizing light after being illuminated.

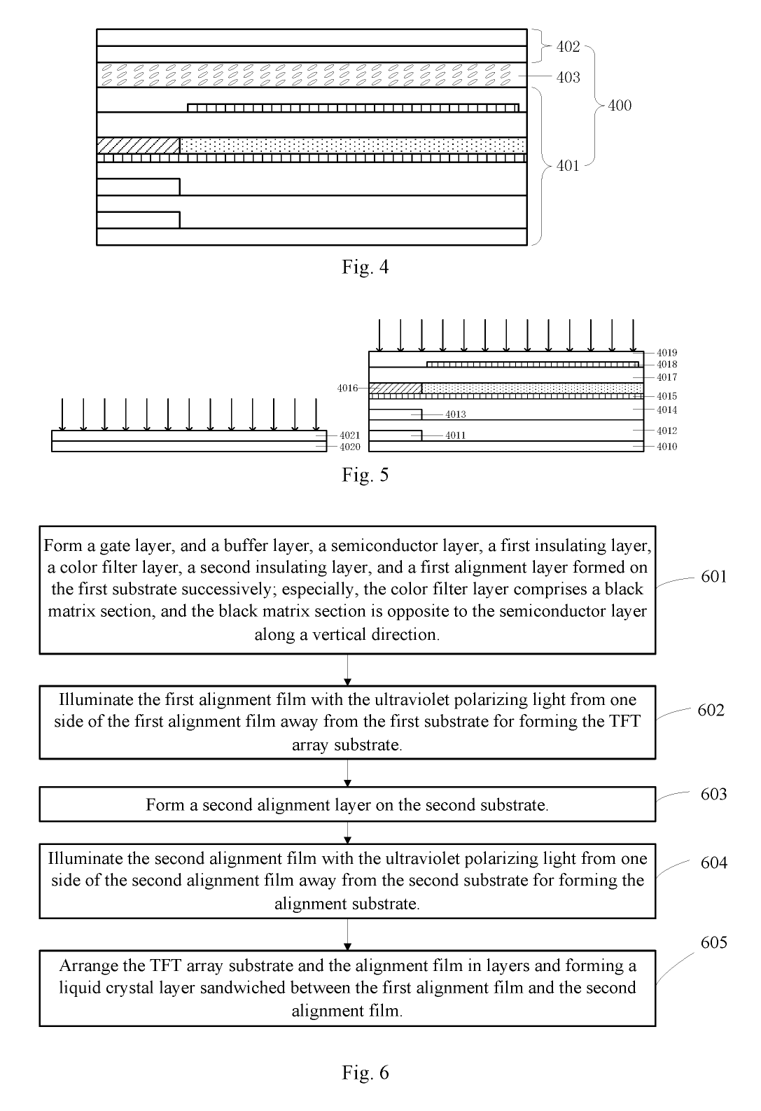

Please refer to FIG. 4 showing a schematic diagram of a display panel according to one embodiment of the present invention. The display panel 400 comprises a TFT array substrate 401, an alignment substrate 402, and a liquid crystal layer 403 sandwiched between the TFT array substrate 401 and the alignment substrate 402.

Please refer to FIG. 5. FIG. 5 is a schematic diagram of the new practical structure of a display according to one embodiment of the present invention. A TFT array substrate 401 comprises a first substrate 4010, a gate layer 4011, a buffer layer 4012, a semiconductor layer 4013, a first insulating layer 4014, a color filter layer 4016, a second insulating layer 4017, and a first alignment layer 4019. And the gate layer 4011, the buffer layer 4012, the semiconductor layer 4013, the first insulating layer 4014, the color filter layer 4016, the second insulating layer 4017, and the first alignment layer 4019 are formed on the first substrate 4010 successively. Besides, a common electrode layer 4015 is further arranged between the first insulating layer 4014 and the color filter layer 4016, and a pixel electrode layer 4018 is further arranged between the second insulating layer 4017 and the first alignment layer 4019 in this embodiment.

The alignment substrate 402 comprises a second substrate 4020 and a second alignment layer 4021 formed on the second substrate 4020.

The first alignment layer 4019 and the second alignment layer 4021 are arranged near the liquid crystal layer 403.

One side of the TFT array substrate 401 near the alignment film and one side of the alignment substrate 402 near the alignment film are illuminated by the ultraviolet polarizing light, respectively. When the ultraviolet polarizing light illuminates the alignment film from one side of the alignment principle substrate, the black matrix section can block the ultraviolet polarizing light and prevent the ultraviolet polarizing light from illuminating the semiconductor layer in the process of photo-alignment for the TFT substrate. In this way, the performance of the semiconductor will not be affected by the ultraviolet polarizing light after being illuminated.

Please refer to FIG. 6. FIG. 6 is a flow chart of a method of fabricating a display panel according to one embodiment of the present invention. The method comprises:

Step 601: Form a gate layer, and a buffer layer, a semiconductor layer, a first insulating layer, a color filter layer, a second insulating layer, and a first alignment layer formed on the first substrate successively; especially, the color filter layer comprises a black matrix section, and the black matrix section is opposite to the semiconductor layer along a vertical direction.

In one concrete embodiment, the step is of forming a gate layer, a buffer layer, a semiconductor layer, a first insulating layer, a common electrode layer, a color filter layer, a second insulating layer, a pixel electrode layer, and a first alignment layer on a first substrate successively.

Step 602: Illuminate the first alignment film with the ultraviolet polarizing light from one side of the first alignment film away from the first substrate for forming the TFT array substrate.

The wavelength of the ultraviolet polarizing light ranges from 200 nm to 400 nm.

Step 603: Form a second alignment layer on the second substrate.

Step 604: Illuminate the second alignment film with the ultraviolet polarizing light from one side of the second alignment film away from the second substrate for forming the alignment substrate.

Step 605: Arrange the TFT array substrate and the alignment film in layers and forming a liquid crystal layer sandwiched between the first alignment film and the second alignment film.

In another embodiment, the direction of the connection of a black matrix section and a semiconductor layer and a vertical direction form a preset angle. Step 602 is of illuminating a first alignment film with an ultraviolet polarizing light at the preset angle from one side of the first alignment film away from a first substrate for forming a TFT array substrate.

Compared with conventional technology, the color filter layer is arranged in the TFT substrate in the present embodiment. When the ultraviolet polarizing light illuminates the alignment film from one side of the alignment principle substrate, the black matrix section can block the ultraviolet polarizing light and prevent the ultraviolet polarizing light from illuminating the semiconductor layer in the process of photo-alignment for the TFT substrate. In this way, the performance of the semiconductor will not be affected by the ultraviolet polarizing light after being illuminated.

The present disclosure is described in detail in accordance with the above contents with the specific preferred examples. However, this present disclosure is not limited to the specific examples. For the ordinary technical personnel of the technical field of the present disclosure, on the premise of keeping the conception of the present disclosure, the technical personnel can also make simple deductions or replacements, and all of which should be considered to belong to the protection scope of the present disclosure.

What is claimed is:

1. A thin-film transistor (TFT) array panel, comprising a first substrate, and a gate layer, a buffer layer, a semiconductor layer, a first insulating layer, a color filter layer, a second insulating layer, and a first alignment layer formed on the first substrate successively, the color filter layer comprising a black matrix section, and the black matrix section being opposite to the semiconductor layer along a vertical direction,
wherein the alignment substrate comprises a second substrate and a second alignment layer formed on the second substrate, and the first alignment layer and the second alignment layer are arranged near the liquid crystal layer.

2. The TFT array panel of claim 1, wherein
a common electrode layer is further arranged between the first insulating layer and the color filter layer;
a pixel electrode layer is further arranged between the second insulating layer and the first alignment layer.

3. The TFT array panel of claim 1, wherein
the buffer layer is either a SiOx layer or a SiNx layer;
each of the first insulating layer and the second insulating layer is an organic insulating layer.

4. The TFT array panel of claim 1, wherein the semiconductor layer is an indium gallium zinc oxide (IGZO) layer.

5. The TFT array panel of claim 1, wherein a direction of connection of the black matrix section and the semiconductor layer and a vertical direction form a preset angle.

6. A display panel, comprising a thin-film transistor (TFT) array panel, an alignment substrate, and a liquid crystal layer sandwiched between the TFT array substrate and the alignment substrate;
the TFT array panel comprising a first substrate, and a gate layer, a buffer layer, a semiconductor layer, a first insulating layer, a color filter layer, a second insulating layer, and a first alignment layer formed on the first substrate successively, the color filter layer comprising a black matrix section, and the black matrix section being opposite to the semiconductor layer along a vertical direction;
the alignment substrate comprising a second substrate and a second alignment layer formed on the second substrate, and the first alignment layer and the second alignment layer being arranged near the liquid crystal layer.

7. The display panel of claim 6, wherein
a common electrode layer is further arranged between the first insulating layer and the color filter layer;
a pixel electrode layer is further arranged between the second insulating layer and the first alignment layer.

8. The display panel of claim 6, wherein
the buffer layer is either a SiOx layer or a SiNx layer;
each of the first insulating layer and the second insulating layer is an organic insulating layer.

9. The display panel of claim 6, wherein the semiconductor layer is an indium gallium zinc oxide (IGZO) layer.

10. The display panel of claim 6, wherein a direction of connection of the black matrix section and the semiconductor layer and a vertical direction form a preset angle.

11. A method of fabricating a display panel, comprising:
forming a gate layer, a buffer layer, a semiconductor layer, a first insulating layer, a color filter layer, a second insulating layer, and a first alignment layer on a first substrate successively, the color filter layer comprising a black matrix section, and the black matrix section being opposite to the semiconductor layer along a vertical direction;
illuminating the first alignment film with an ultraviolet polarizing light from one side of the first alignment film away from the first substrate for forming a thin-film transistor (TFT) array substrate;
forming a second alignment layer on the second substrate;
illuminating the second alignment film with the ultraviolet polarizing light from one side of the second alignment film away from the second substrate for forming an alignment substrate;
arranging the TFT array substrate and the alignment film in layers and forming a liquid crystal layer sandwiched between the first alignment film and the second alignment film.

12. The method of claim 11, wherein the step of forming the gate layer, the buffer layer, the semiconductor layer, the first insulating layer, the color filter layer, the second insulating layer, and the first alignment layer on the first substrate successively comprises concrete steps of:
forming a gate layer, a buffer layer, a semiconductor layer, a first insulating layer, a common electrode layer, a color filter layer, a second insulating layer, a pixel electrode layer, and a first alignment layer on the first substrate successively.

13. The method of claim 11, wherein a direction of connection of the black matrix section and the semiconductor layer and a vertical direction form a preset angle;
the step of illuminating the first alignment film with the ultraviolet polarizing light from one side of the first alignment film away from the first substrate for forming the TFT array substrate concretely comprising:
illuminating the first alignment film with the ultraviolet polarizing light at the preset angle from one side of the first alignment film away from the first substrate for forming the TFT array substrate.

14. The method of claim 11, wherein the wavelength of the ultraviolet polarizing light ranges from 200 nm to 400 nm.

15. The method of claim 11, wherein
the buffer layer is either a SiOx layer or a SiNx layer;
each of the first insulating layer and the second insulating layer is an organic insulating layer.

16. The method of claim 11, wherein the semiconductor layer is an indium gallium zinc oxide (IGZO) layer.
